(19) United States
(12) Patent Application Publication
(10) Pub. No.: US 2016/0136743 A1
(43) Pub. Date: May 19, 2016

(54) AUXILIARY DEVICE FOR CUTTING IN BANDSAW

(71) Applicant: OTORO DESIGN INC., Shizuoka (JP)

(72) Inventors: Shunsuke WATANABE, Shizuoka-shi, Shizuoka (JP); Masaru YOSHIDA, Shizuoka-shi, Shizuoka (JP)

(21) Appl. No.: 14/890,025

(22) PCT Filed: May 10, 2013
(86) PCT No.: PCT/JP2013/063169

§ 371 Date: Feb. 2, 2016

(51) Int. Cl. B23D 59/00; B23D 55/00

(52) U.S. Cl. CPC B23D 59/003; B23D 55/00

(57) ABSTRACT

A device to project the shape of a cutting line with respect to a workplace on a board face of a working board in a band saw includes: a working board support section provided in a main body in order to adjustably support a working board with a flexible steel strip as the center and fix the working board at an arbitrary position and posture; and a light beam projector which projects the shape of the cutting line with respect to the workpiece to the board face of the working board, the light beam projector is positioned on the side surface of a band saw main body so as to project a light beam parallel to a cutting surface by the flexible steel strip and there is a projection section mounted by using a joint which can change the projection direction to an arbitrary direction.

### TECHNICAL FIELD

The present invention relates to a cutting auxiliary device in a band saw which cuts a workpiece by using a flexible steel strip.

### BACKGROUND ART

In work of performing cutting by using a band saw, a cutting operation taking into account drift of a flexible steel strip, which is commonly called a blade, is needed. The drift of a blade is a phenomenon that even if a workpiece is straight fed against the blade, the workpiece is gradually shifted to the right or the left without being cut straight, and is regarded as being caused by a tendency of the blade, a wood grain, or the like. If a cutting operation is performed while neglecting drift, even if a straight edge is used, cutting cannot be performed in accordance with a marking line drawn on a workpiece, and therefore, each one corrects the direction of the straight edge such that the drift is canceled out, and then performs the work.

In contrast, Japanese Unexamined Patent Application Publication No. 06-270102 proposes a feeding device which is mounted on a manual feed type band saw and provided with a mounting body formed so as to be able to be fixed to a surface of the straight edge in a state where a lower end portion is brought into contact with a surface plate, a feed roller which is supported on the mounting body and formed so as to be able to perform separation and approaching movement with respect to the surface plate with an axis maintained substantially parallel to the surface plate, a spring which is provided at the mounting body and biases the feed roller in a direction approaching the surface plate, and a drive motor which rotates the feed roller. However, if feeding is forced such that the feeding device is positioned by the straight edge, a steel strip has a tendency to be pulled or pushed due to drift, and thus, an excessive force is applied, and therefore, it is not possible to overcome a drift problem.

The inventor of the present invention has obtained, from the result of trial and error, recognition that there is no way except grasping drift inherent in a workpiece which is a processing target and matching the drift direction and a cutting line, in order to overcome a drift problem. For this reason, a method of indicating a drift direction on a workpiece shape has been developed. However, commercially available band saws have a variety of shapes and structures, and thus, it is not easy to mount on them and accurately indicate the drift direction.

[Patent Citation 1] Japanese Unexamined Patent Application Publication No. 06-270102

### DISCLOSURE OF INVENTION

### Technical Problem

The present invention has been made in view of the above points and an object thereof is to use a light beam, make a projection direction of the light beam arbitrarily adjustable, and make it possible to accurately project the shape of a cutting line with respect to a workpiece to the board face of a working board, in order to enable correction of so-called blade drift. Further, another object of the present invention is to be easily mountable on the existing band saw, realize accurate correction, and easily perform objective cutting.

### Technical Solution

In order to solve the above problem, according to the present invention, there is provided an auxiliary device for cutting in a band saw, which is a device made so as to project a cutting shape with respect to a workpiece to a board face of a working board in a band saw which cuts the workpiece by using a flexible steel strip, including: a working board support section provided at a main body in order to adjustably support the working board with the flexible steel strip as the center and fix the working board at an arbitrary position and in an arbitrary posture; and a light beam projector which projects the shape of a cutting line with respect to the workpiece to the board face of the working board, in which the light beam projector is equipped on a side surface of a band saw main body so as to illuminate a light beam parallel to a cutting surface by the flexible steel strip and takes means for mounting and configuring a projection section by using a joint which can change a projection direction to an arbitrary direction.

A band saw which is a target of the present invention is a machine which cuts a workpiece by using a flexible steel strip having almost the same concept as a band saw, and is also referred to as a band saw (board), and in many cases, wood is a processing target. However, for example, a so-called woodworking board, a paper working material, a resin material, light metal, a composite material, or the like, other than wood is also a processing target.

The band saw has a basic configuration in which a pair of wheels is disposed up and down and a flexible steel strip having a so-called endless belt shape is wound around the wheels. As a table for work, a working board is present between the upper and lower wheels, and a workpiece is moved on the working board to the flexible steel strip which is set at a cutting edge plate portion of the working board, whereby an objective cutting operation is performed. Further, a slit for the passage of the flexible steel strip is formed in a cutting edge plate. Among the above, a portion on which the pair of upper and lower wheels is mounted, the cutting edge plate portion, and the like belong to the band saw main body side.

The board face of the working board is a surface on which work of cutting a workpiece is performed, and therefore, the board face of the working board takes a horizontal posture, and a cutting movement direction of the flexible steel strip is orthogonal to the board face at that time. However, it is also possible to take a posture inclined from the horizontal posture in order to perform cutting in a non-orthogonal state on a workpiece. Further, a slit for the passage of a blade is formed toward the cutting edge plate for the passage of the flexible steel strip from an end of the board face.

In the device according to the present invention, a cutting shape with respect to a workpiece is projected to the board face of the working board. For this purpose, the device according to the present invention is provided with a working board support section provided at a main body in order to adjustably support the working board with the flexible steel strip as the center and fix the working board at an arbitrary position and in an arbitrary posture, and a light beam projector which projects the shape of a cutting line with respect to the workpiece to the board face of the working board. The light beam projector is equipped on the side surface of a band saw main body so as to irradiate a light beam parallel to a cutting surface by the flexible steel strip, and has a projection section mounted by using a joint which changes a projection direction.

The light beam projector is equipped on the side surface of the band saw main body so as to illuminate a light beam parallel to a cutting surface by the flexible steel strip, whereby the light beam can be projected to the board face of the working board without being disturbed by any person. In particular, the light beam is irradiated parallel to the cutting surface and perpendicular to the board face, whereby the light beam becomes parallel to a workpiece feed direction, and therefore, a concern about blocking the light beam during work is also reduced. The light beam projector is acceptable if it can project the shape of the cutting line with respect to the workpiece. Most of all, a laser beam projector which projects a laser beam is most suitable as the light beam projector and can clearly project a linear laser beam to the board face of the working board. Therefore, the light beam projector as referred to in the present invention may be considered as referring to a laser beam projector.

The working board support section can support the working board so as to be horizontally rotatable around the flexible steel strip when the working board takes a horizontal posture. That is, the working board is rotatable around the flexible steel strip in a horizontal plane. Further, the working board support section is made so as to be able to support the working board so as to be horizontally rotatable around the flexible steel strip, even when the working board does not take a horizontal posture. A rotation range is acceptable if it is a range necessary to correct drift which is expected in the cutting of wood.

Further, in the device according to the present invention, by being equipped with the laser beam projector which is mounted on the band saw main body side and projects, in a case where a cutting line deviates from a straight line when straight cutting a workpiece on the working board by the flexible steel strip, a light beam so as to overlap the deviated cutting line, correction of drift is possible. The laser projector is means for projecting a straight line onto the working board face, and as equipment, the type of equipment is not particularly limited if it is possible to achieve the purpose, and it is possible to use commercially available equipment in which straight line projection is possible.

### Advantageous Effects

The present invention is configured and operated as described above, and therefore, an effect is exhibited that a light beam is used, a projection direction of the light beam can be arbitrarily adjusted, and the shape of a cutting line with respect to a workpiece can be accurately projected to the board face of the working board, in order to enable correction of so-called blade drift. Further, according to the present invention, an effect of being easily mounted on the existing band saw, realizing an accurate correction, and easily performing objective cutting is exhibited.

### BEST MODE FOR CARRYING OUT THE INVENTION

Hereinafter, a cutting auxiliary device in a band saw according to the present invention will be described in more detail with reference to an embodiment shown in the drawings. In each drawing, reference numeral 10 demotes a band saw, 11 denotes a main body of the band saw, 12 and 13 denote a pair of upper and lower wheels, and 14 denotes an endless belt-shaped flexible steel strip wound around the wheels. As a table for work, a working board 15 is present between the pair of upper and lower wheels 12 and 13, and a cutting edge plate 16 is present at an inside portion of a board face thereof, and a slit 17 for passage of the flexible steel strip 14 is formed thereon (refer to FIG. 2).

The working board 15 has a board face 18 having a square planar shape for performing work of cutting a workpiece, and a flange 19 on which the cutting edge plate 16 can be placed is mounted in an opening of a central portion. Further, a working board support section 21 is provided in order to support the working board 15 so as to be horizontally rotatable around the flexible steel strip 14 (refer to FIG. 3). The working board support section 21 has one purpose of supporting the working board 15 so as to be horizontally rotatable around the flexible steel strip 14 when the working board 15 takes a horizontal posture. The working board support section 21 shown in the drawings is composed of a base portion 22 having a circular planar shape, which is installed on the band saw main body side, and a receiving portion 24 which is disposed on the circular base portion and has a circular recessed portion 23 which is fitted to the circumference of the circular base portion 22.

The base portion 22 and the receiving portion 24 have configurations capable of being integrally fixed to each other by fastening the base portion 22 and the receiving portion 24 by a fastener 25. The fastener 25 has a flange portion 26 and a male screw 27 at a shaft portion on the tip side of an operating lever, and a partner section 29 having a female screw 28 which is screwed to the male screw 27 is provided integrally with the working board 15 and enables the rotation of the working board 15 in the range of an elongated hole 30 in a rotation direction formed in the base portion 22. The fastener 25, the flange portion 26, the male screw 27, the female screw 28, and the partner section 29 configure a working board fixing section for fixing the working board 15 to the receiving portion 24 on the band saw main body side.

A working board guide section 31 which guides the working board 15 in order to incline the working board 15 with respect to the flexible steel strip 14 is formed in a downward arc shape on the lower surface of the base portion 22 of the working board support section 21. The working board guide sections 31 are provided at equal intervals at a minimum of two locations in a circumferential direction centered on the flexible steel strip 14, and an elongated hole 32 is formed along each arcuate surface, and a bolt 33 movable along the arcuate surface is provided in the elongated hole 32.

Guide section receiving sections 34 and 34 are provided corresponding to the guide sections 31 and 31 on the working board side in the same number of locations and same positional relationship at a member 35 on the band saw main body 11 side. The guide section receiving section 34 has an arcuate groove portion 36 capable of coming into slide contact with the working board guide section 31 having a downward arc shape, and a bold passage hole 37 is provided at a central portion of each guide section receiving section 34. Reference numeral 38 denotes a fixing member, and the fixing member 38 has a nut 39 which is screwed to the bolt 33.

The band saw main body 11 is provided with a light beam projector 40 which projects the shape of a cutting line with respect to a workpiece to the board face of the working board 15. The light beam projector 40 is equipped on the side surface of the band saw main body 11 so as to illuminate a light beam parallel to a cutting surface by the flexible steel strip 14, and a projection section 42 is mounted by using a joint 41 which changes a projection direction (refer to FIGS. 4A and 4B). Reference numeral 43 denotes a laser oscillation section, 44 denotes an ON-OFF switch, 45 denotes a cord, and 46 denotes a substrate. The light beam projector 40 is a laser beam projector which projects a laser beam, and the laser beam is configured so as to project a linear laser beam to the board face of the working board 15.

The band saw according to the present invention has a switch 47, a vertical movement type blade guide 48, a guide operating handle 49, an upper wheel adjustment knob 50, and a belt tension adjustment handle 51, as shown in FIG. 1. Further, the cutting auxiliary device according to the present invention having such a configuration can support the working board 15 by the working board support section 21 so as to be horizontally rotatable around the flexible steel strip 14 when the working board 15 takes a horizontal posture. That is, the working board 15 is rotatable around the flexible steel strip 14 in a horizontal plane.

Therefore, a cutting operation can be performed by fitting a workpiece W to a straight edge 42 provided at the working board 15, fitting a marking line drawn in the workpiece W to the flexible steel strip 14, starting the band saw, and feeding the workpiece W against the flexible steel strip 14. As a result, there is a case where due to drift, a cutting line C deviates from the marking line which is a target, and the state is shown in FIG. 5. In such a case, the laser beam projector 40 mounted on the front of the band saw main body is operated, thereby projecting a laser beam so as to overlap the deviated cutting line C (FIG. 6). In FIG. 6, for convenience of explanation, illustration is made so as to obliquely project a laser beam. However, as is apparent from FIG. 1, the laser beam is projected substantially perpendicularly from the upper side to the board face of the working board 15.

Further, there is a limit to a dimension in which the steel strip 14 can move from side to side, and thus, if drift becomes excessive in a process of cutting the workpiece W while pressing the workpiece W against the straight edge 42, it does not become possible to perform cutting by resistance which is applied to the steel strip 14. Assuming that the state of FIG. 5 is based on an actual size, this exceeds a limit to which the steel strip 14 can move to the left. However, for convenience of explanation, the state of FIG. 5 is that shown to be slightly larger. Subsequently, both the fasteners 25 and 25 on the lower surface of the working board are loosened, the working board 15 is rotated around the flexible steel strip 14, a handle 43 of the straight edge 42 is loosened and moved in parallel on the working board, the straight edge 42 is fitted to a laser beam irradiation line L, and thereafter, both the fasteners 25 and 25 are tightened, and the handle 43 is tightened and fixed (FIG. 7). Accordingly, drift adjustment is performed by fitting the straight edge 42 which is a mark on the working board to the laser beam irradiation line L projected from the laser beam projector 40.

In this way, it is possible to accurately cut the workpiece W in accordance with the marking line by feeding the workpiece W while fitting the workpiece W to the straight edge 42 subjected to the drift adjustment (this is the state of FIG. 8). In use of the device according to the present invention, how much drift can be appropriately grasped is important, and for accurate grasp of the drift, it is required to not disturb the accurate feed of a workpiece and the movement of a workpiece different from the resulting feed direction. Therefore, as described above, even if the straight edge 42 is used when feeding the workpiece W, the movement or the workpiece W to the right or left in the feed direction is affected by drift, and therefore, feeding the workpiece W such that the influence becomes as small as possible is effective in the accurate grasp of drift. Further, it is possible to incline the working board 15 by loosening the fixing member 38 and bringing the working board guide section 31 having a downward arc shape into slide contact with the arcuate groove portion 36. The inclination of the working board 15 is possible even when the working board 15 is being rotated, and after the inclination is set, the fixing member 38 is tightened and fixed. A cutting operation with respect to the workpiece W can be performed in a state where the working board 15 is inclined in an arbitrary direction.

### BRIEF DESCRIPTION OF DRAWINGS

FIG. 1 is a side view showing the whole of a band saw with a cutting auxiliary device according to the present invention applied thereto.

FIG. 2 is a cross-sectional view of a working board portion in the present invention.

FIG. 3 is an exploded perspective view showing the lower surface of a working board.

FIGS. 4A and 4B are diagrams showing an example of a light beam projector which is used in the present invention, in which FIG. 4A is a front view and FIG. 4B is a side view.

FIG. 5 is an explanatory diagram showing a state where drift has occurred.

FIG. 6 is an explanatory diagram showing a laser beam irradiation state.

FIG. 7 is an explanatory diagram showing a state where the working board has been rotated.

FIG. 8 is an explanatory diagram showing a cutting operation state after drift adjustment.

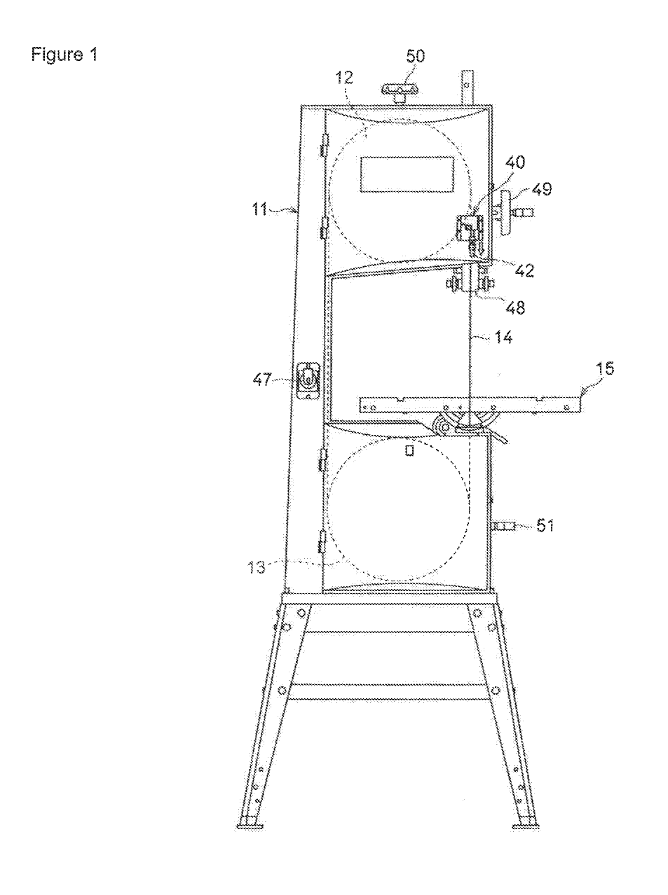

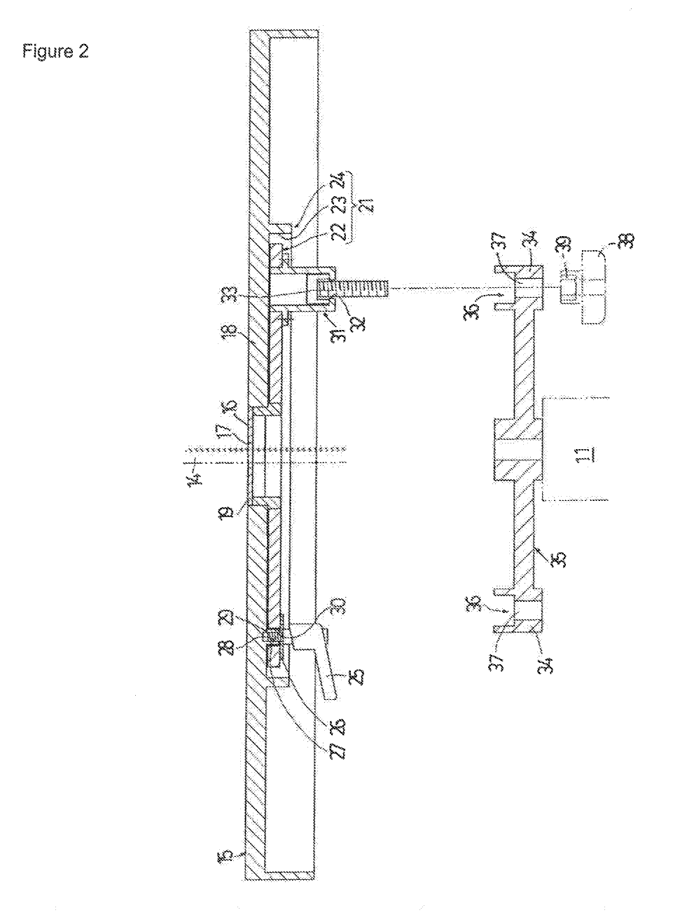

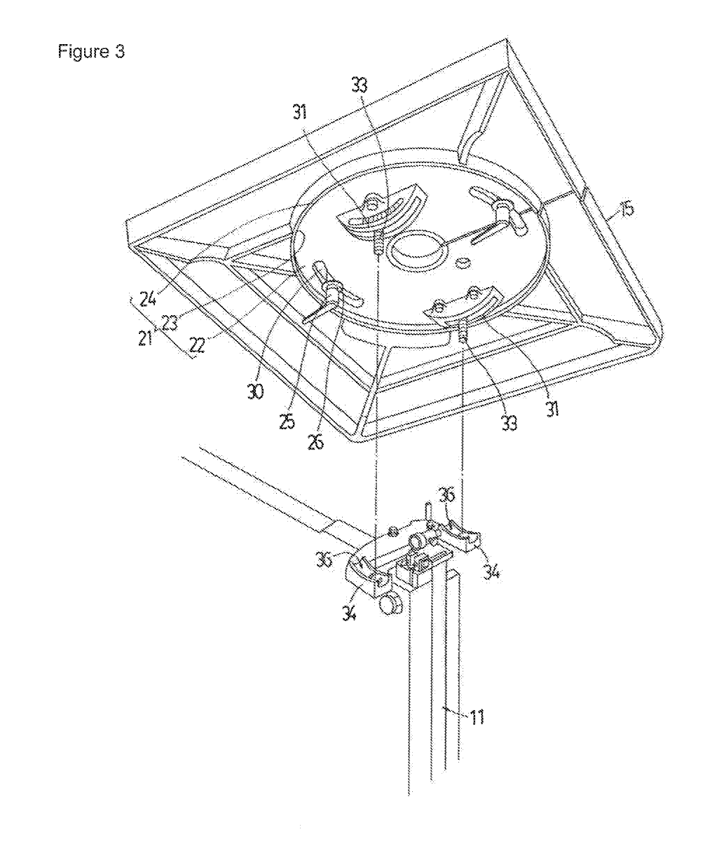

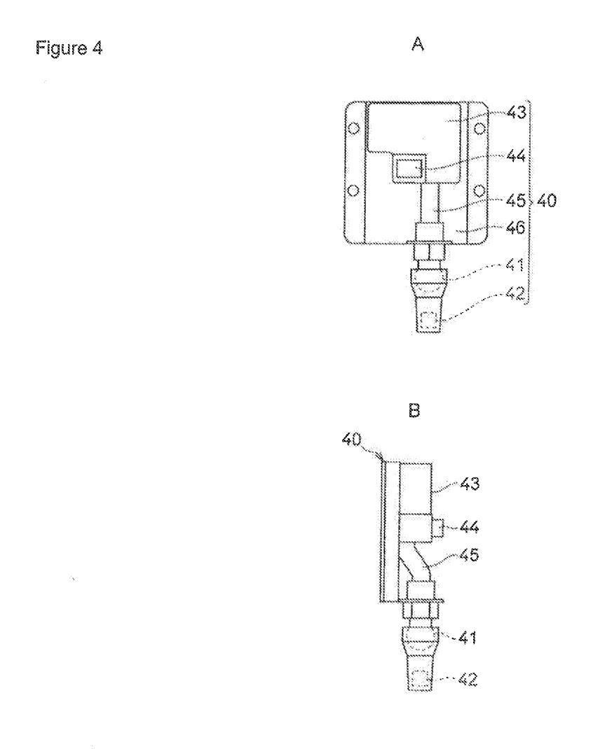

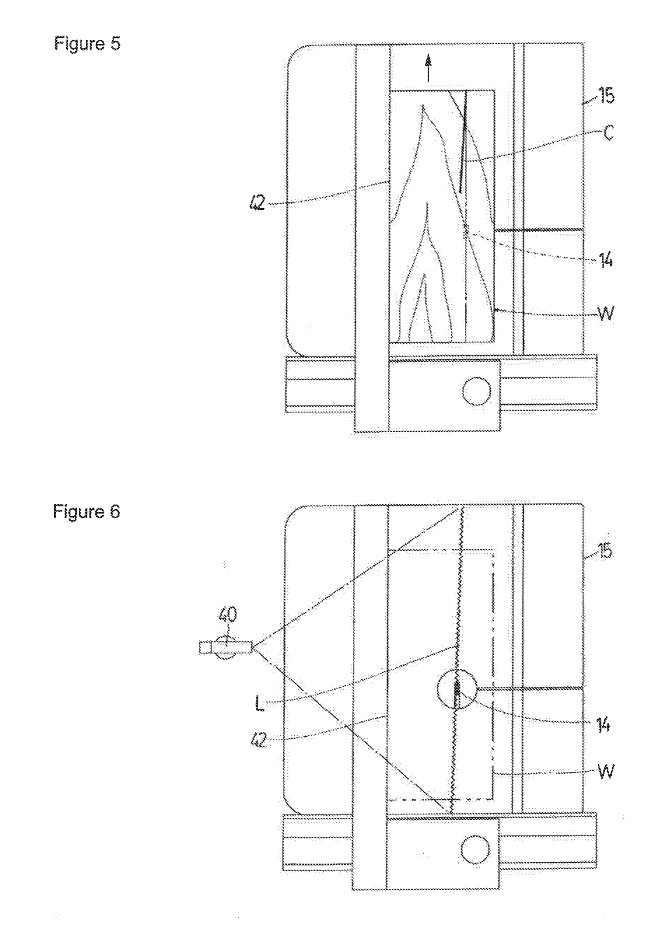

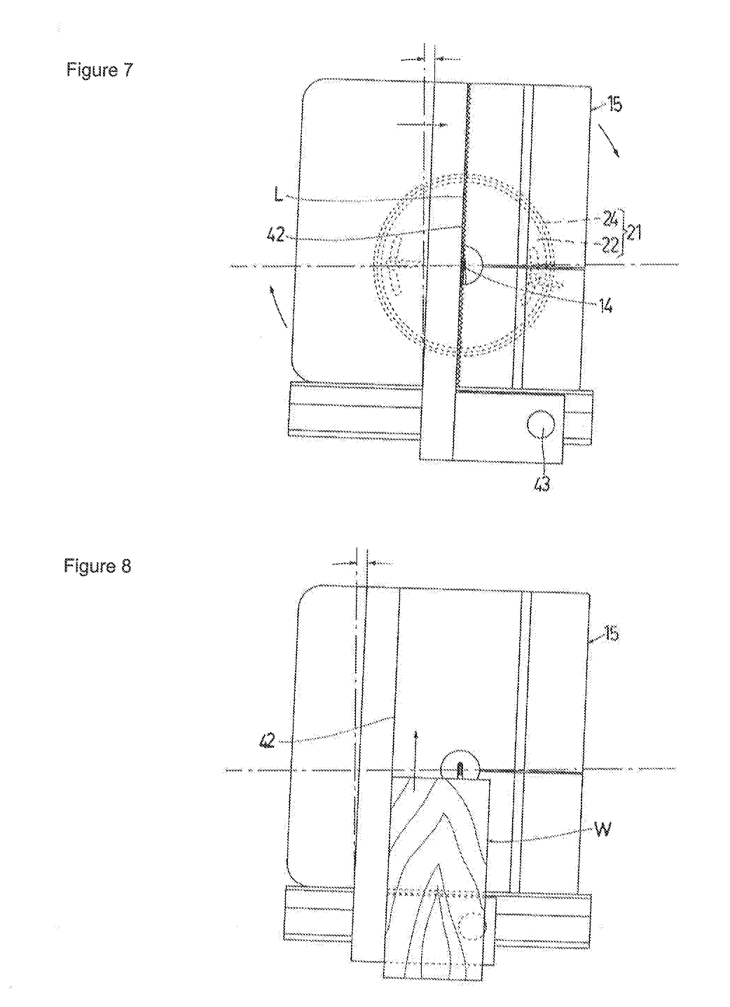

### EXPLANATION OF REFERENCE

10: band saw

11: band saw main body

12, 13: wheel

14: flexible steel strip

15: working board

16: cutting edge plate

17: slit

18: board face

21: working board support section

22: base portion

23: recessed portion

24: receiving portion

25: fastener

29: partner member

31: working board guide section

40: laser beam projector

41: joint

42: projection section

43: transmission section

44: switch

45: cord

46: substrate

1. An auxiliary device for cutting in a band saw, which is a device made so as to project a shape of a cutting line with respect on a workpiece to a board face of a working board in a band saw which cuts the workpiece by using a flexible steel strip, comprising:
a working board support section provided in a main body in order to adjustably support the working board with the flexible steel strip as the center and fix the working board at an arbitrary position and arbitrary posture; and
a light beam projector which projects the shape of the cutting line with respect to the workpiece to the board face of the working board,
wherein the light beam projector is positioned on a side surface of a band saw main body so as to project a light beam parallel to a cutting surface by the flexible steel strip and there is a projection section mounted by using a joint which can change a projection direction to an arbitrary direction.

2. The auxiliary device for cutting in a band saw according to claim 1, wherein the light beam projector is a laser beam projector which projects a laser beam, and the laser beam is configured so as to project a linear laser beam to the board face of the working board.
